(19) United States
(12) Patent Application Publication
(10) Pub. No.: US 2002/0166070 A1
(43) Pub. Date: Nov. 7, 2002

(54) Method and apparatus to reduce errors of a security association

(76) Inventors: Avraham Mualem, Portland, OR (US); Linden Minnick, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/849,126

(22) Filed: May 4, 2001

(51) Int. Cl. G06F 11/30; G06F 15/173

(52) U.S. Cl. 713/201; 713/150; 714/37; 709/224

(57) ABSTRACT

Embodiments of a method and apparatus to reduce errors of security association are described.

### BACKGROUND

This disclosure is related to security and, more particularly, to security for network adapters.

Information Handling Apparatuses (IHAs), e.g. devices that handle, store, display or process information, such as computers, for example, may transmit and receive data and/or information in packet format between itself and other IHAs over a network. The IHA may include a host memory and may be coupled via a local bus to a network adapter. A network may include a plurality of interconnected nodes, and may comprise, for example, without limitation, a system of computers, settop boxes, peripherals, servers and/or terminals coupled by communications lines or other communications channels. In a local area network, a network adapter, also generally known as a network controller or network interface card (NIC), may be used to process information or data between the IHA and the network.

IHAs may typically include an operating system and a network driver that initializes data from the IHA that is to be transported via the network. In an effort to efficiently offload the processing network traffic securely, cryptographic information may be stored and processed on the network adapter. Data and cryptographic information may be passed between the IHA and the network adapter before being transferred over the network. Such cryptographic information may include information to secure the data before being transferred between the network and the IHA.

Cryptographic information, referred to herein as a Security Association (SA), typically may include one or more of the following: encryption keys, authentication keys, a Security Parameters Index (SPI), a protocol type, and a destination IP address. The term SA is not meant to be limiting herein and may include any cryptographic information that includes one or more of the preceding.

When receiving data, a network adapter typically may execute the following procedure. The SA may be passed to a network driver by an operating system on the IHA. The network driver on the IHA may transfer the SA to the network adapter. Once the network adapter has received the SA, it may parse, e.g. separate into components, the incoming data packets. Then the network adapter typically matches the SPI, protocol type, and destination internet protocol (IP) address in the data packet with one of the SAs that it has stored in its internal memory. If it finds a match, the network adapter may decrypt and/or authenticate the incoming packet received over the network before it passes data within the packet to host memory in the IHA.

### BRIEF DESCRIPTION OF THE DRAWINGS

The subject matter is particularly pointed out and distinctly claimed in the concluding portion of the specification. This claimed subject matter, however, both as to organization and method of operation, together with objects, features, and advantages thereof, may best be understood by reference of the following detailed description when read with the accompanying drawings in which:

FIG. 1 is a block diagram of one embodiment of a system to reduce errors of a security association; and

FIG. 2 is a flow diagram of one embodiment of a method to reduce errors of a security association.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

Data may be transferred to a network adapter from an IHA and vice versa using a direct memory access (DMA) device or any device that transfers data into memory. When transferring to the network adapter, the DMA or other device may request control of an input/output (I/0) bus and read a sequence of data from memory on the IHA and write this data into memory on the network adapter. When transferring data to the IHA, the DMA or other device reads data from the network adapter and transfers this data to the IHA. This procedure of transferring data from the IHA to the network adapter may become complicated if the SA data becomes corrupted while it is being transferred to the network adapter by the IHA. Although the claimed subject matter is not limited to addressing the following, corruption could occur if, for example, the network adapter or the local bus is “under stress” while the SA is being transferred. Stress may occur when there is more data or information to be received in the network adapter then the network adapter has the capability to timely process. There are several different ways that a corrupted SA may result in problems.

For example, if the SPI or destination IP address within the SA becomes corrupted, then the SA may not match with incoming data packets. As a result of this, these packets may not be decrypted and/or authenticated efficiently by the network adapter. The IHA may, in some situations, decrypt the data packets in software resulting in system performance degradation.

Alternatively, if authentication keys in the SA are corrupted, a packet that matches with the corrupted SA may be reported as having an incorrect authentication signature. As a result, these packets may be dropped and be retransmitted over the network. This may result in a connection loss if the SA corruption is not detected and the procedure times out.

If the encryption keys of the SA are corrupted, then packets that match with the SA may be decrypted incorrectly. This situation may result in problems when operating in “tunnel mode.” In tunnel mode the data packet's Internet Protocol (IP) header containing an IP address and data are encrypted. If the encryption keys are corrupted, then the IP address may be corrupted.

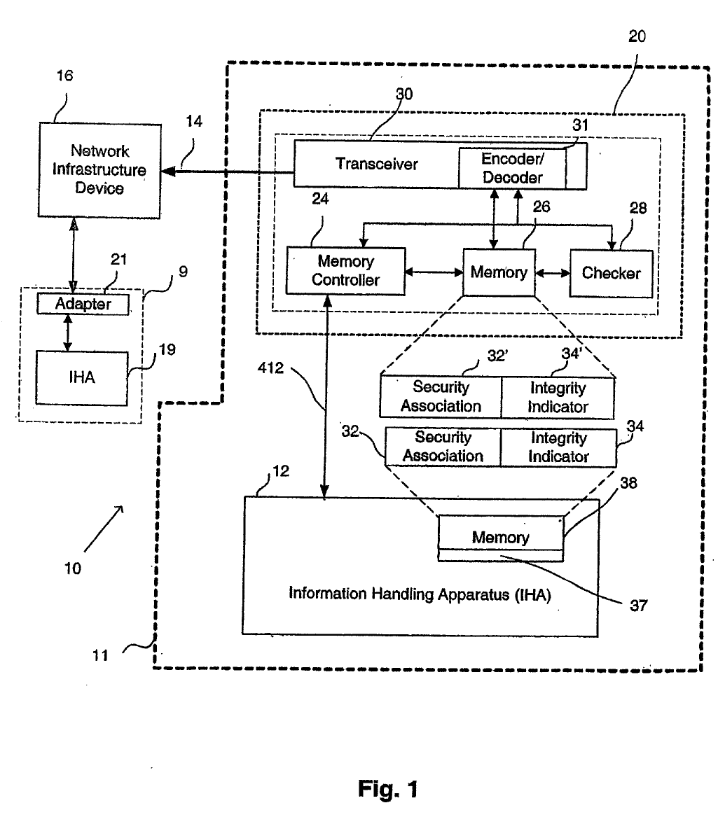

Although the claimed subject matter is not limited in scope in this respect, FIG. 1 illustrates one embodiment of a network communications system 10 including network node 11, network media 14, network infrastructure device 16, and network node 9. Node 11 includes an information handling apparatus (IHA) 12 coupled to a network adapter 20, generally referred to as a network interface card (NIC) or network controller. Although the claimed subject matter is not limited in scope in this respect, for the purposes of this embodiment, it will be assumed that nodes 9 and 11 are substantially similar. Likewise, node 9 includes IHA 19 coupled to network adapter 21.

IHA 12 includes a memory 38 that may contain data to be transferred. Adapter 20, although shown in FIG. 1 integrated into node 11 with IHA 12, for example, may be separate from IHA 12 and comprise multiple functional units 24-31. Likewise, adapter 20 may comprise a single integrated circuit (IC), multiple ICs or could be integrated into circuitry within IHA 12.

Adapter 20 transfers and receives information or data in packet form to and from IHA 19 within node 9 via network media 14 and network infrastructure device 16. As with IHA 12, IHA 19 may comprise, without limitation, any device, machine, computer or processor that handles, routes, or processes information or data. Network infrastructure device 16 may comprise an apparatus for routing, switching, repeating or passing information or data via a network such as a router, server, switch or hub, for example. Network media 14, the medium in which data is transferred, comprises, but is not limited to, wires, optical fiber cables, or radio waves.

Network adapter 20 may transmit data read from memory 38 across network media 14 in packet form. Network adapter 20 may receive data packets via network media 14 and store the received data packets or data from the received packets into memory 38.

In one embodiment, adapter 20 is coupled to IHA 12 in node 11. The adapter is not meant to be limited to being mechanically coupled to IHA 12 and may be electrically or optically connected with IHA 12 through any means or technique. Network adapter 20 may be coupled via I/O bus 412 to IHA 12, for example, as illustrated.

IHA 12 in this embodiment executes an operating system and network driver 37 having instructions stored in memory 38 that produces the functionality described hereinafter. In this embodiment, IHA 12 stores in memory 38 the data to be transmitted over the network and generates (as described below) a security association 32 for such data along with an associated integrity indicator 34. The computed security association 32 and associated integrity indicator 34 may then be stored in memory 38. Although not limited to the foregoing, in this embodiment, integrity indicator 34 may be computed from security association 32 using such data integrity checking methods as: checksum or cyclical redundancy checking (CRC) computations, Huffman coding, parity checking, hash computations, etc. IHA 12 executing driver 37 may then provide a signal to network adapter 20, over bus 412, for example, indicating that the security association 32 and the associated integrity indicator 34 in memory 38 are available for storage to network adapter 20.

In one embodiment, network adapter 20 may comprise an integrated circuit having a memory controller 24 capable of transmitting and receiving signals to and from bus 412, a memory 26, an integrity indicator checker 28, and an encoder/decoder 31 within transceiver 30. Memory controller 24 may receive security association 32 and associated integrity indicator 34 from IHA 12 using direct memory access (DMA) or other transfer methods from memory 38. In this embodiment, checker 28 sends a signal to memory controller 24 causing it to write received security association 32′ and associated integrity indicator 34′ into memory 26. Security association 32′ and associated integrity indicator 34′ have been transferred across bus 412 and are stored in memory 26, as distinguished from security association 32 and associated integrity indicator 34 that are stored in memory 38. In alternate embodiments, signals may be provided to memory controller 24 from other sources, such as the IHA 12, for example, to cause it to write received security association 32′ and associated integrity indicator 34′ into memory 26.

Encoder/decoder 31 encrypts information, such as data, before it is transmitted from transceiver 30 via network media 14. Encoder/decoder 31 decrypts data after being received by transceiver 30 via network media 14. Such data may be encrypted and decrypted using well-known methods. Examples of such methods include without limitation: Data Encryption Standard (DES) as described in Federal Information Processing Standards Pub 46-1, Jan. 22, 1988; Advanced Encryption Standard (AES) as described in the Federal Information Processing Standards Draft, Feb. 28, 2001; Message Digest 5 (MD5) as published by MIT Library for Computer Science and RSA in RFC 1321, Apr. 1992; or Secure Hash Algorithm 1 (SHA1), Federal Information Processing Standards Pub 180-1, May 11, 1993.

Checker 28 may include a computational device such as, but not limited to, a state machine, an arithmetic logic unit (ALU) or a processor that conducts arithmetic computations. Checker 28 may verify the integrity of the security association 32′ by computing a second integrity indicator from security association 32′ stored in memory 26 using the same method to the one used by network driver 37 to compute integrity indicator 34. However, in this respect, the term “same” is not limited to being identically the same and may include computing an integrity indicator that is substantially the same or has any similarity. This second integrity indicator may then be compared by checker 28 against integrity indicator 34′ stored in memory 26. If the values of the two integrity indicators match, checker 28 in this embodiment, causes memory controller 24 to write such indication to memory 38 in IHA 12. However, in this respect, the term “match” or “matches” is not limited to being identically the same and may include a determination if the integrity indicators are substantially the same, are not the same or have any similarity. Checker 28 may also transfer security association 32′ to encoder/decoder 31 to enable the encoding of data from IHA 12 before the data is transmitted onto network media 14, and to enable the decoding of data packets from network media 14 before data within such packets are transferred to IHAL 2. Encoder/Decoder 31 using known decoding techniques may decode the data packets. Memory controller 24 may transfer data from the decoded data into memory 38.

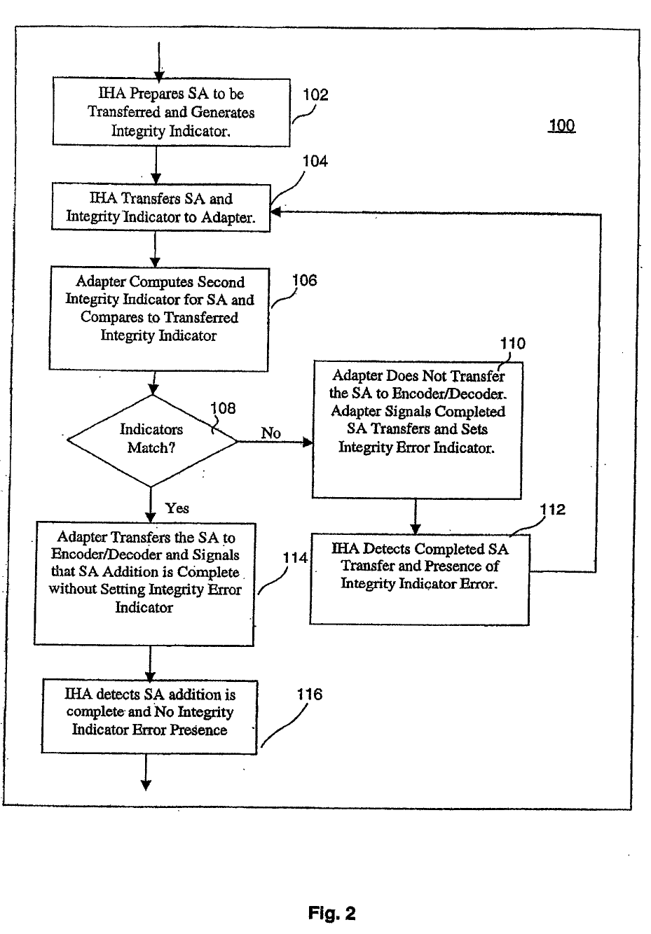

Although the claimed subject matter is not limited in scope in this respect, FIG. 2 illustrates one embodiment of a method 100 for reducing errors in a security association. IHA 12 by executing program code, such as but not limited to, an operating system, may initiate method 100 by a program call. In block 102, IHA 12 executing program code, such as, but not limited to, network driver 37, may prepare the SA using known techniques and calculate an associated integrity indicator 34, from the security association 32, using, for example, one of the methods previously described. Integrity indicator 34 may be stored in memory 38.

In block 104, IHA 12, executing network driver 37, may provide an indication to network adapter 20. This indication may result in network driver 37 transferring SA 32 and integrity indicator 34 from IHA 12 and may result in the loading of the received security association 32′ and integrity indicator 34′ into memory 26. Network adapter 20 in block 106 using checker 28 calculates a second integrity indicator from the security association 32′ in memory 26, by again, using, for example, one of the methods previously described, and compares the value of the second integrity indicator against the associated integrity indicator 34′ stored in memory 26.

In the described embodiment in block 108, network adapter 20 determines if the associated integrity indicator 34′ in memory 26 matches the second integrity indicator. If the integrity indicators do not match, in block 110 the network adapter 20 in this embodiment, does not provide security association 32′ to encoder/decoder 31, and network adapter 20 provides an indication to IHA 12 by setting an integrity error indicator bit in memory 38 to indicate that security association 32′ contains an integrity error. However, in this respect, the term setting an integrity error indicator bit is not limited to setting a bit and may including providing a flag, setting a register location or any method that provides an indication to IHA 12. IHA 12 may, by executing network driver 37 in block 112, for example, detect that the security association 32′ received by the network adapter 20 contains an error and re-execute block 104.

Alternatively, if the integrity indicators match in block 108, in block 114, network adapter 20 transfers security association 32′ to encoder/decoder 31 from memory 26. Network adapter 20 also provides an indication to memory 38 in IHA 12 using memory controller 24 that the security association transfer to encoder/decoder 31 is complete and sets the integrity error indicator bit in memory 38 to indicate a successful transfer of the security association to network adapter 20. In block 116, IHA 12 may, by, in this embodiment, executing network driver 37, detect that security association 32′ was received by network adapter 20 with acceptable integrity and may return execution control to the operating system.

In the preceding description, various aspects of the presently claimed subject matter have been described. For purposes of explanation, specific numbers, systems and configurations are set forth in order to provide a thorough understanding of the present claimed subject matter. However, it is apparent to one skilled in the art having the benefit of this disclosure that the present claimed subject matter may be practiced without the specific details. In other instances, well-known features were omitted or simplified in order not to obscure the present claimed subject matter.

Embodiments of the claimed subject matter may be implemented in hardware, firmware or software, or a combination thereof. Likewise, embodiments may be implemented as computer programs executing on programmable systems comprising at least one processor, a data storage system (including volatile and non-volatile memory and/or storage elements), at least one input device, and at least one output device, for example. Program code may be applied to input data to perform the functions described herein and generate output information. The output information may be applied to one or more output devices, in known fashion. The program code may also be implemented in assembly or machine language, if desired. Furthermore, the claimed subject matter is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device, readable by a general or special purpose programmable processing system, for configuring and operating the processing system when the storage media or device is read by the processing system to perform the procedures described herein. The claimed subject matter may also be considered to be implemented as a machine-readable storage medium, configured for use with a processing system, where the storage medium so configured causes the processing system to operate in a specific and predefined manner to perform the functions described herein.

While certain features have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. A method of transferring a security association (SA) comprising:
verifying that a SA within an information handling apparatus (IHA) prior to being transferred to a network adapter is substantially similar to the SA within the network adapter after being transferred.

2. The method of claim 1, wherein verifying that the SA within the IHA prior to being transferred to the network adapter is substantially similar to the SA within the network adapter after being transferred further comprises:
transferring the SA and an associated integrity indicator to the network adapter from the IHA;
verifying the integrity of the SA after being transferred to the network adapter; and
indicating the integrity of the SA to the IHA.

3. The method of claim 2, wherein verifying the integrity of the SA further comprises computing a computed associated integrity indicator from the SA after transferring; comparing the computed associated integrity indicator against the associated integrity indicator after transferring; and wherein indicating the integrity of the SA to the IHA further comprises providing an indication to the IHA in response to the comparing.

4. The method of claim 3, wherein providing the indication comprises setting an integrity error indicator bit in a memory on the IHA.

5. An integrated circuit comprising:
a network adapter operative to receive a security association (SA) and a received associated integrity indicator from an Information Handling Apparatus (IHA), said adapter including an integrity indicator checker operative to verify an integrity of the SA.

6. The integrated circuit of claim 5, wherein said network adapter is coupled to a bus, said bus being coupled to the IHA.

7. The integrated circuit of claim 6, wherein the integrity indicator checker is operative to compute a computed associated integrity indicator from the received SA, and to verify the integrity of the SA by comparing the received associated integrity indicator with the computed associated integrity indicator.

8. The integrated circuit of claim 7, wherein the integrity indicator checker is operative to compute the computed associated integrity indicator from the SA using one of the following integrity checking methods: a cyclical redundancy checking computations method, a checksum computations method, a parity checking method, a Huffman coding method and a hash computation method.

9. The integrated circuit of claim 7, wherein said adapter further comprises a memory controller operative to indicate the results of the comparing to a memory on the IHA.

10. The integrated circuit of claim 5, further comprising:
a transceiver operative to transfer packets encrypted with the SA to a network, said transceiver being operative to receive packets from the network and to decrypt the packets with the SA.

11. A network adapter comprising:
a memory controller operative to receive a security association (SA) and a received associated integrity indicator from an Information Handling Apparatus (IHA);
a transceiver operative to transmit onto a network, packets encrypted with the SA; and
an integrity indicator checker operative to verify an integrity of the SA using the received associated integrity indicator.

12. The network adapter of claim 11, wherein the integrity indicator checker is operative to compute a computed associated integrity indicator from the received SA, and is operative to verify the integrity of the SA by comparing the received associated integrity indicator with the computed associated integrity indicator.

13. The network adapter of claim 12, wherein said memory controller is operative to transfer a result of the comparing to a memory on the IHA.

14. The network adapter of claim 11, wherein said transceiver is operative to receive packets from the network and to decrypt the packets with the SA.

15. An article comprising: a storage medium, said storage medium having stored thereon instructions, that, when executed in an Information Handling Apparatus (IHA) coupled to a network adapter, result in security association (SA) integrity protection by:
transferring a SA from the IHA to the network adapter; and
transferring an associated integrity indicator from the IHA to the network adapter.

16. The article of claim 15, wherein the network adapter is operative to determine the integrity of the SA and to transfer the indication of the integrity of the SA to a memory in the IHA, and wherein the instructions further result in: reading the indication of the integrity of the SA from the memory after the network adapter determines the integrity of the SA.

17. The article of claim 15, wherein the instructions further result in: computing the associated integrity indicator of the SA before transferring the SA to the network adapter using an integrity checking method.

18. The article of claim 16, wherein the instructions further result in: transferring a second SA and a second associated integrity indicator from the IHA to the network adapter in response to reading the indication of the integrity of the SA.

19. An network communication system comprising:
an information handling apparatus (IHA) coupled to a network adapter, said IHA being operative to transfer a security association (SA) and an associated integrity indicator to the network adapter;
the network adapter being operative to verify the integrity of the SA, to provide an indication of the integrity of the SA to the IHA and to transmit packets encrypted with the SA via a network.

20. The network communication system of claim 19, wherein the network adapter is operative to read the transferred SA and associated integrity indicator, and wherein the network adapter is operative verify the integrity of the SA by computing a computed integrity indicator from the transferred SA with an integrity checking method, and determining if the associated integrity indicator and the computed integrity indicator match.

21. The network communications system of claim 20, wherein the network adapter is operative to provide an indication if the associated integrity indicator and the computed integrity indicator match.

22. The network communications system of claim 20, wherein the network adapter is operative to transfer a second SA and a second associated integrity indicator from the IHA to the network adapter in response to an indication that the associated integrity indicator and the computed integrity indicator do not match.

23. The network communications system of claim 19, wherein said network adapter is operative to receive packets from the network and to decrypt the packets with the SA.
